(19) United States
(12) Patent Application Publication
(10) Pub. No.: US 2010/0081043 A1
(43) Pub. Date: Apr. 1, 2010

(54) BATTERY COVER LATCHING MECHANISM

(75) Inventors: GUO-ZHAO HUANG, Shenzhen City (CN); WU-CHUN ZENG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/401,713

(22) Filed: Mar. 11, 2009

(30) Foreign Application Priority Data
Sep. 26, 2008 (CN) 200810304696.1

(51) Int. Cl. H01M 2/10

(52) U.S. Cl. 429/96

(57) ABSTRACT

A battery cover latching mechanism is provided. The battery cover latching mechanism includes a housing, a cover member and a button assembly arranged on the housing. The button assembly includes a pressing member and an elastic member. The pressing member includes a locking block. The cover member includes a locking member. The locking block is detachably interlocked to the locking member. The elastic member is used to push the cover member away from the housing.

### BACKGROUND

1. Field of the Invention

The present invention relates to battery cover latching mechanisms and, particularly, to a battery cover latching mechanism used in a portable electronic device.

2. Description of Related Art

Portable electronic devices usually include housings, battery covers and latching mechanisms used to latch the battery cover to the housing. Latching mechanisms must tolerate frequent installation and removal of batteries from the housing.

A typical battery cover latching mechanism includes at least one spring. However, the spring may easily wear out after repeated operation and, thus the battery cover latching mechanism may fail.

Therefore, there is room for improvement within the art.

### BRIEF DESCRIPTION OF THE DRAWINGS

Many aspects of the battery cover latching mechanism can be better understood with reference to the following drawings. These drawings are not necessarily drawn to scale, the emphasis instead being placed upon clearly illustrating the principles of the present battery cover latching mechanism. Moreover, in the drawings like reference numerals designate corresponding sections throughout the several views.

FIG. 1 is an exploded, isometric view of a battery cover latching mechanism, in accordance with an exemplary embodiment.

FIG. 2 is another exploded, isometric view of the battery cover latching mechanism shown in FIG. 1.

FIG. 3 is a partially isometric view of the cover section shown in FIG. 1.

FIG. 4 is an isometric view of the button assembly shown in FIG. 1.

FIG. 5 is an isometric, assembled view of the battery cover latching mechanism shown in FIG. 1.

FIG. 6 is a cross-sectional view of the battery cover latching mechanism shown in FIG. 5 taken along line VI-VI.

FIG. 7 is a cross-sectional view of the battery cover latching mechanism shown in FIG. 5 taken along line VII-VII.

FIG. 8 is a cross-sectional view of the battery cover latching mechanism shown in FIG. 5 taken along line VIII-VIII.

### DETAILED DESCRIPTION OF EXEMPLARY EMBODIMENT

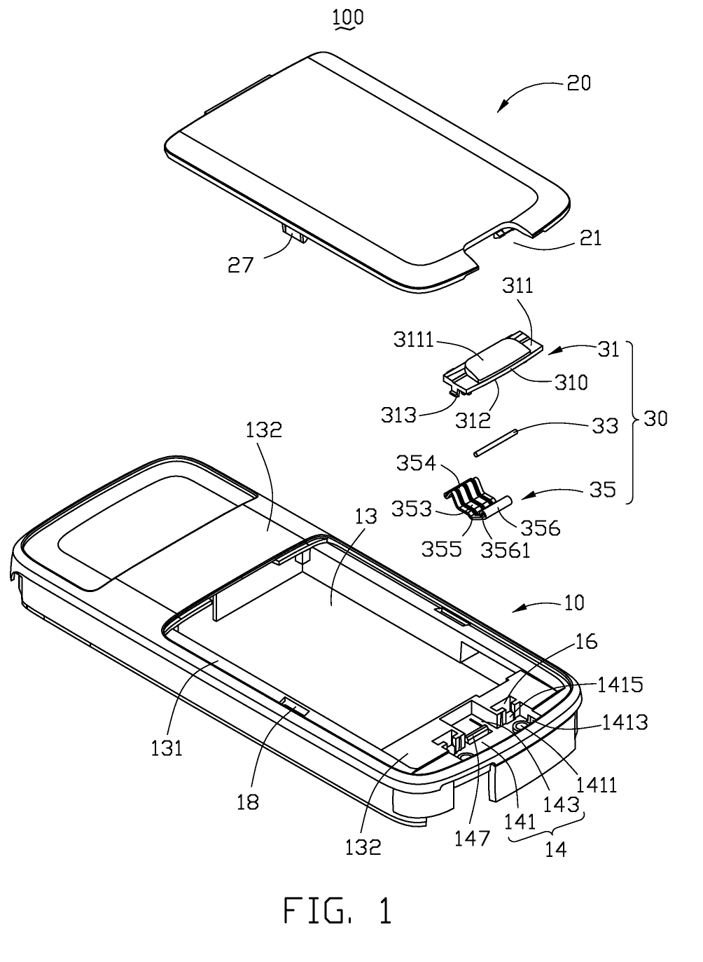

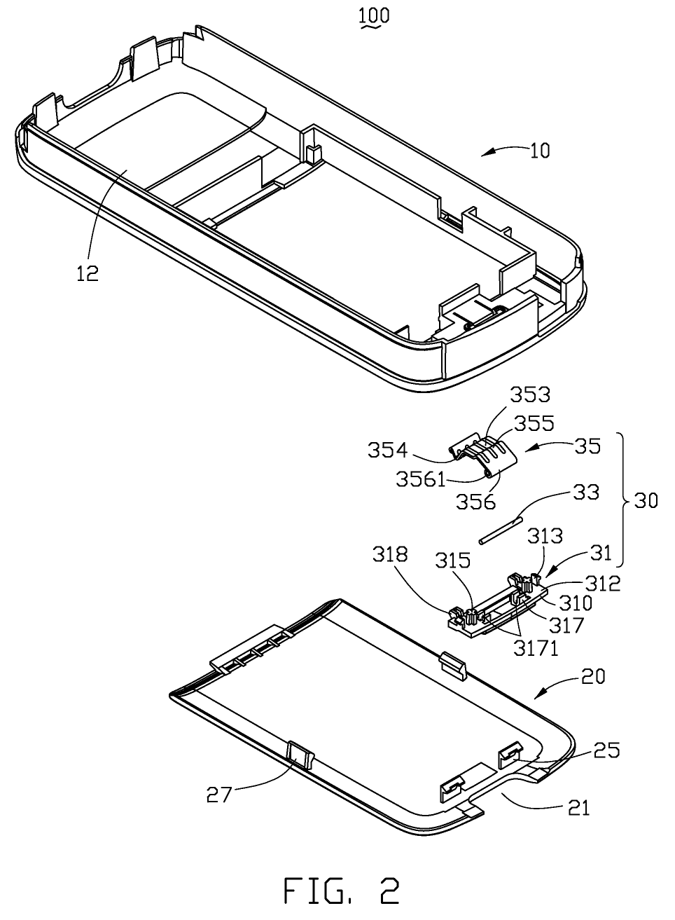

FIGS. 1 and 2 show an exemplary battery cover latching mechanism 100 used in portable electronic devices, such as mobile phones, digital cameras, etc. The battery cover latching mechanism 100 includes a housing 10, a cover member 20 and a button assembly 30. The cover member 20 can be detachably mounted to the housing member 10 by the button assembly 30.

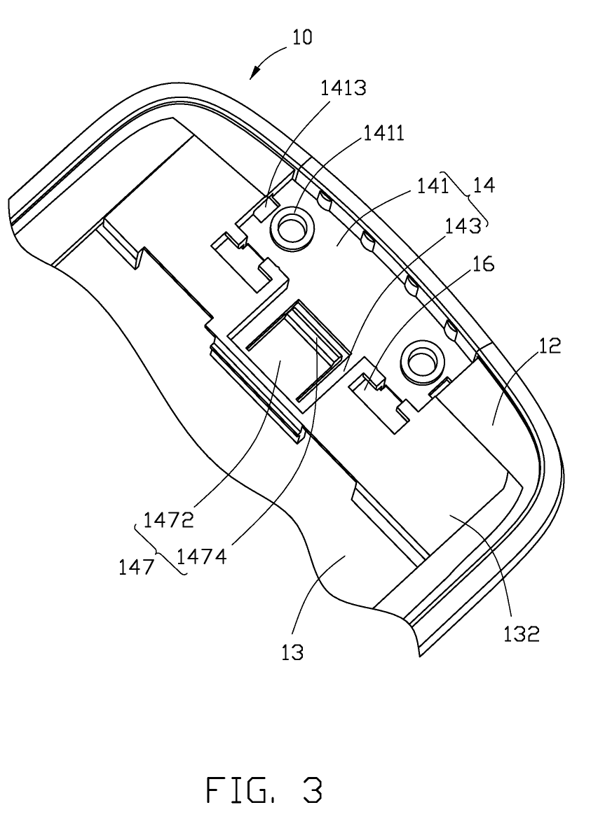

Also referring to FIG. 3, the housing member 10 defines a battery receiving space 13 used to receive a battery (not shown). The battery receiving space 13 is enclosed by two opposite side walls 131 and two opposite end walls 132. One of the two end walls 132 defines a generally T-shaped receiving cavity 14. The receiving cavity 14 includes a first receiving compartment 141 and a second receiving compartment 143. The first receiving compartment 141 has two hollow positioning poles 1411 protruding from the end wall 132. The end wall 132 further defines two opposite through apertures 1413 and two adjacent fastening holes 16 communicating with the first receiving compartment 141. The two fastening holes 16 are arranged between the positioning poles 1411 and the battery receiving space 13. An elastic arm 147 protrudes from the end wall 132 inside the second receiving compartment 143. The elastic arm 147 includes a connecting portion 1472 and a first resisting portion 1474. The two side walls 131 of the housing member 11 define two opposite limiting holes 18.

Referring to FIG. 2, the cover member 20 defines a cutout 21 at one of its ends and corresponding to the receiving cavity 14. Two L-shaped locking members 25 protrude from the cover member 20 adjacent to the cutout 21. Two opposite limiting clamps 27 are formed on the cover member 20 corresponding to the limiting holes 18.

The button assembly 30 includes a pressing member 31, a fastening shaft 33 and an elastic member 35.

The pressing member 31 includes a top wall 311 and an opposite bottom wall 312. The top wall 311 has a pressing portion 3111 thereon. Two fastening poles 315 and two elastic clamps 313 protrude from two opposite sides of the bottom wall 312. Two locking blocks 318 are arranged on a third side of the bottom wall 312 corresponding to the locking members 25. The bottom wall 312 forms two securing blocks 317 thereon between the fastening poles 315. Each securing block 317 defines a U-shaped well 3171.

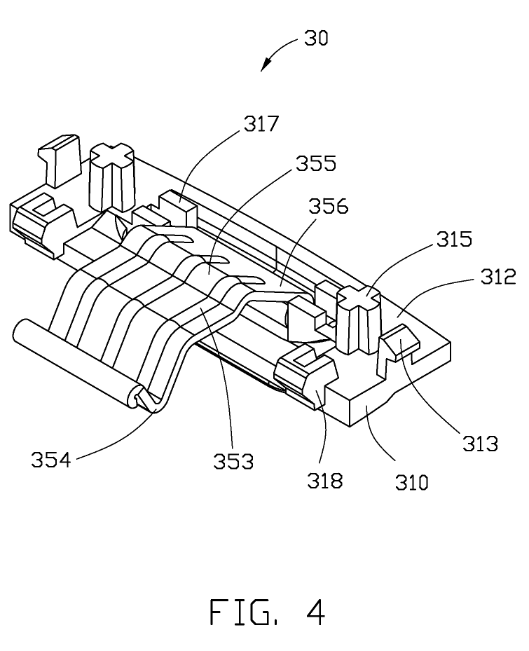

Referring to FIG. 4, the elastic member 35 includes a flat portion 353, a second resisting portion 354, a supporting portion 355 and a fastening portion 356. The second resisting portion 354 is generally V-shaped and connected with an end of the flat portion 353. The supporting portion 355 is connected with another end of the flat portion 353, opposite to the second resisting portion 354. The fastening portion 356 is a sleeve connected with the supporting portion 355, distal to the flat portion 353. The fastening portion 356 defines a through hole 3561 configured to receive the fastening shaft 33 therein. The fastening shaft 33 can be secured in the wells 3171.

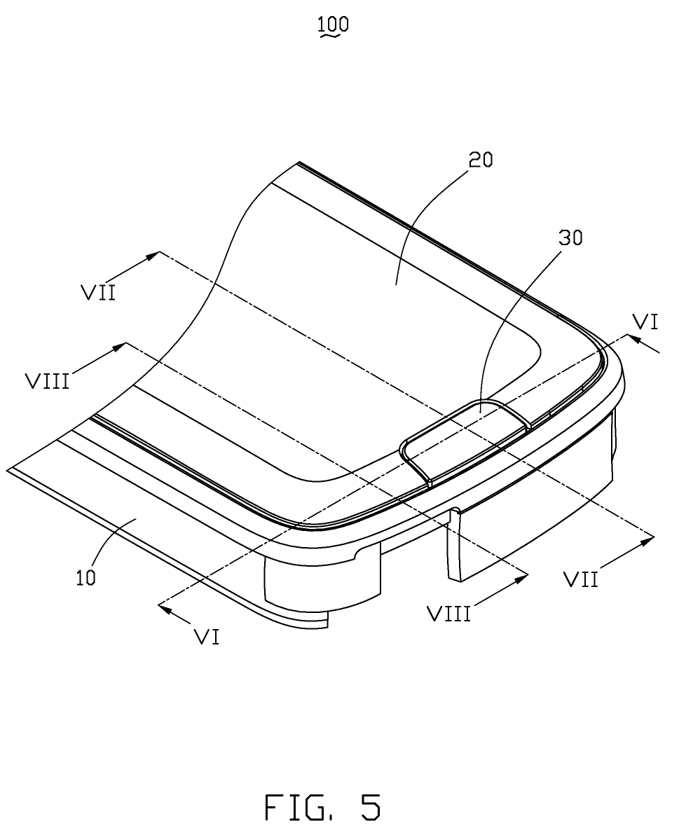

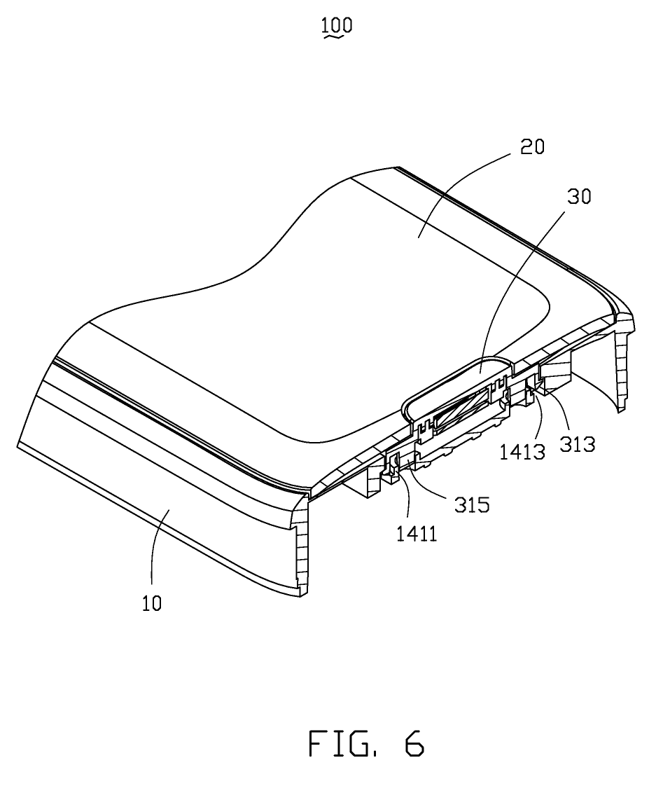

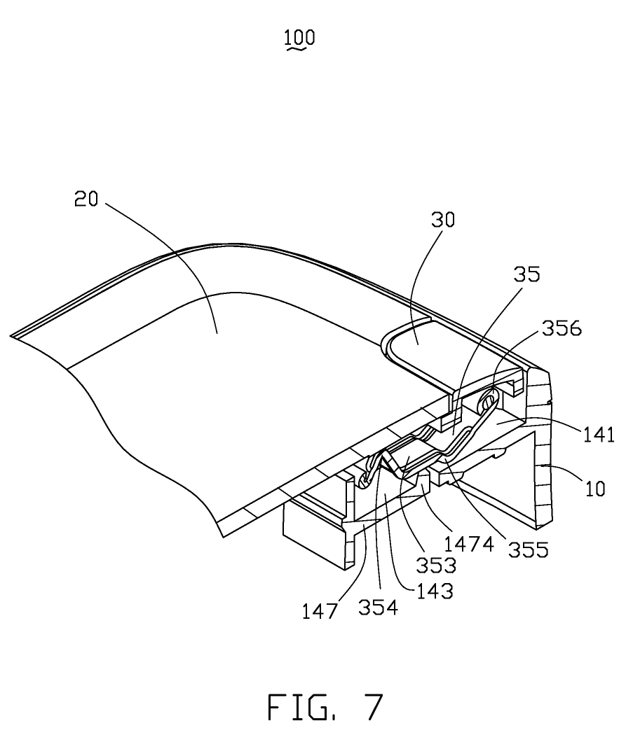

Referring to FIGS. 5 to 7, to mount the button assembly 30 to the housing member 10, the fastening poles 315 are inserted into the hollow positioning poles 1411. The elastic clamps 313 deformably latch into the through apertures 1413. Thus, the button assembly 30 is secured in the receiving cavity 14 of the housing member 10. The locking blocks 318 are received in the fastening holes 16. The elastic member 35 is partly received in the second receiving compartment 143 (best seen in FIG. 7). The flat portion 353 deformably resists against the first resisting portion 1474 and the supporting portion 355 deformably resists against the bottom of the first receiving compartment 141.

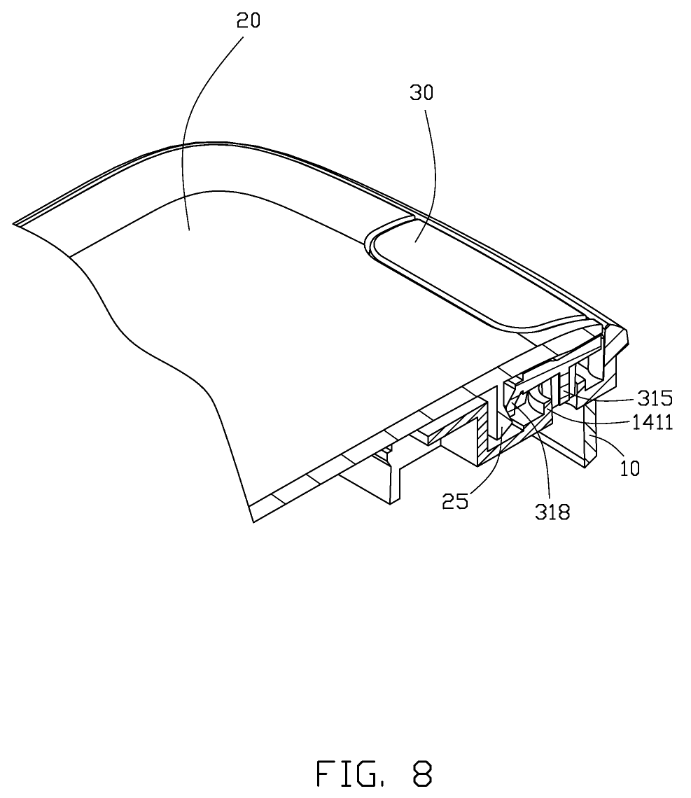

Referring to FIG. 8, to latch the cover member 20 to the housing member 10, the limiting clamps 27 are secured into the limiting holes 18. Then, the cover member 20 can be pivoted towards the housing member 11 until the locking members 25 interlocks with the locking blocks 318.

Referring to FIGS. 7 and 8, to release the cover member 20, the button assembly 30 is pressed towards the housing member 10 to drive the fastening portion 356 into the receiving cavity 14. At this time, the second resisting portion 354 of the elastic member 35 pivots around the supporting portion 355 toward the cover member 20 to release the locking members 25 from the locking blocks 318. At this time, the cover member 20 is automatically released from the housing member 11 under the elastic force of the first resisting portion 1474 of the elastic arm 147.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of sections within the principles of the invention to the full extent indicated by the broad general meaning of the terms, in which the appended claims are expressed.

What is claimed is:

1. A battery cover latching mechanism, comprising:
a housing;
a cover member being detachably mounted to the housing; and
a button assembly associated with the housing, the button assembly including a pressing member and an elastic member, the pressing member having a locking block, the cover member having a locking member, the locking block being detachably interlocked with the locking member, the pressing member mounted on the housing, the elastic member including a supporting portion, a fastening portion and a second resisting portion, the fastening portion secured to the pressing member, the supporting portion abutting against the housing, the resisting portion pushing the cover member to release the locking member from the locking block when the elastic member pivots around the supporting portion.

2. The battery cover latching mechanism as claimed in claim 1, wherein two securing blocks protrude from the pressing member, each securing block defines a well, the fastening portion defines a through hole, the button assembly further includes a fastening shaft, the fastening shaft received in the through hole and secured in the wells.

3. The battery cover latching mechanism as claimed in claim 2, wherein the housing defines a receiving cavity, the button assembly is mounted in the receiving cavity.

4. The battery cover latching mechanism as claimed in claim 3, wherein the pressing member includes two elastic clamps, the housing defines two opposite corresponding through apertures, the elastic clamps are securely inserted in the apertures.

5. The battery cover latching mechanism as claimed in claim 3, wherein two fastening poles protrude from the pressing member, the housing defines two corresponding hollow positioning poles, the fastening poles are inserted in the positioning poles.

6. The battery cover latching mechanism as claimed in claim 3, wherein the housing member defines two fastening holes for receiving the locking blocks therein.

7. The battery cover latching mechanism as claimed in claim 3, wherein the elastic member further includes a flat portion, the second resisting portion is generally V-shaped and connected with an end of the flat portion, the supporting portion connected with an end of the flat portion opposite to the second resisting portion.

8. The battery cover latching mechanism as claimed in claim 7, wherein an elastic arm is arranged on the bottom of the receiving cavity abuts against the flat portion to release the cover member when the locking member is released from the locking block.

9. The battery cover latching mechanism as claimed in claim 1, wherein the cover member includes two limiting clamps, the housing member includes two corresponding limiting holes, the limiting clamps inserted into the limiting holes.

10. The battery cover latching mechanism as claimed in claim 1, wherein the cover member defines a cutout used to partly receive the pressing member therein.

11. A battery cover latching mechanism, comprising:
a housing;
a cover member being detachably mounted to the housing; and
an elastic member including a supporting portion and a resisting portion, the supporting portion abutting against the housing, the resisting portion pushing the cover member away from the housing when the elastic member pivots around the supporting portion.

12. The battery cover latching mechanism as claimed in claim 11, further comprising a pressing member, wherein the pressing member is fixed to the elastic member.

13. The battery cover latching mechanism as claimed in claim 12, wherein the pressing member has a locking block, the cover member has a locking member, the locking block is detachably interlocked with the locking member, the resisting portion pushing the cover member to release the locking member from the locking block when the elastic member pivots around the supporting portion.

14. The battery cover latching mechanism as claimed in claim 12, further comprising a fastening shaft, wherein two securing blocks protrude from the pressing member, each securing block defines a well, the elastic member defines a through hole, the fastening shaft is received in the through hole and secured in the wells.
